(19) United States
(12) Patent Application Publication
(10) Pub. No.: US 2019/0025564 A1
(43) Pub. Date: Jan. 24, 2019

(54) LIGHT SHEET ILLUMINATION MICROSCOPE

(71) Applicant: OLYMPUS CORPORATION, Tokyo (JP)

(72) Inventor: Go RYU, Tokyo (JP)

(73) Assignee: OLYMPUS CORPORATION, Tokyo (JP)

(21) Appl. No.: 16/035,989

(22) Filed: Jul. 16, 2018

(30) Foreign Application Priority Data
Jul. 21, 2017 (JP) 2017-141696

(51) Int. Cl. G02B 21/06; G02B 21/00

(52) U.S. Cl. CPC G02B 21/06; G02B 21/0032

(57) ABSTRACT

A light sheet illumination microscope 100 includes: an illumination optical system 15 that emits excitation light to a sample from a plurality of directions; an up-and-down stage 11 and a tilt stage 12 that respectively change an emission position and an emission direction of the excitation light emitted by the illumination optical system 15; and a controller 20 that controls the up-and-down stage 11 and the tilt stage 12 according to a switching of a wavelength of the excitation light emitted by the illumination optical system 15, so as to correct a deviation between irradiated planes formed by pieces of excitation light emitted from the plurality of directions.

### CROSS REFERENCE TO RELATED APPLICATIONS

This application is based upon and claims the benefit of priority from prior Japanese Patent Application No. 2017-141696, filed Jul. 21, 2017, the entire contents of which are incorporated herein by this reference.

### BACKGROUND OF THE INVENTION

### Field of the Invention

The present invention relates to a light sheet illumination microscope that illuminates a sample from different directions in the same plane.

### Description of the Related Art

A light sheet illumination microscope is known that irradiates a sample with excitation light from a plurality of different directions in the same plane. For example, US Patent Application Publication No. 2011/115895 discloses the configuration in which a sample is illuminated from two directions perpendicular to an optical axis of a detection optics, and this is a typical configuration.

The illumination of a sample from two directions (a plurality of directions) in the same plane makes is possible to suppress a decrease in the illumination efficiency in an area in the sample that is far from an illumination optical system, and to provide a stripe eliminating effect, wherein the decrease in the illumination efficiency may occur in a configuration in which illumination is performed from one direction.

### SUMMARY OF THE INVENTION

A light sheet illumination microscope according to an aspect of the present invention includes: an illumination optical system that emits excitation light to a sample from a plurality of directions; a light adjustment mechanism that changes an emission position and an emission direction of the excitation light emitted by the illumination optical system; and a controller that controls the light adjustment mechanism according to a switching of a wavelength of the excitation light emitted by the illumination optical system, so as to correct a deviation between irradiated planes formed by pieces of excitation light emitted from the plurality of directions.

### BRIEF DESCRIPTION OF THE DRAWINGS

The present invention will be more apparent from the following detailed description when the accompanying drawings are referenced.

FIG. 1 illustrates a configuration of a light sheet illumination microscope according to a first embodiment;

FIG. 2 illustrates how to measure an angle of excitation light with respect to a specified plane;

FIG. 3 illustrates a function of a controller;

FIG. 4 is a flowchart that illustrates an example of processing performed by the controller 20 when the wavelength of excitation light is switched during observation;

FIG. 5 illustrates a configuration of a light sheet illumination microscope according to a second embodiment;

FIG. 6 illustrates a portion of a configuration of a light sheet illumination microscope according to a third embodiment; and

FIG. 7 illustrates the portion of the configuration of the light sheet illumination microscope according to the third embodiment.

### DESCRIPTION OF THE EMBODIMENTS

In a light sheet illumination microscope that irradiates a sample with excitation light from different directions in the same plane, if observation is performed while switching the wavelength of excitation light, an illumination optical path for each illumination direction may be shifted due to the polishing precision of an optical fiber or an aberration of a lens in an illumination optical system. This may result in illuminating two different planes on the sample. In this case, effects that were supposed to be provided by a light sheet illumination microscope illuminating a sample from different directions in the same plane are not provided.

In light of the problem described above, a primary object of embodiments of the present invention is to provide, to a light sheet illumination microscope that illuminates a sample from different directions, a technology that can correct a deviation between pieces of excitation light from different illumination directions, the deviation occurring when the wavelength of excitation light is switched.

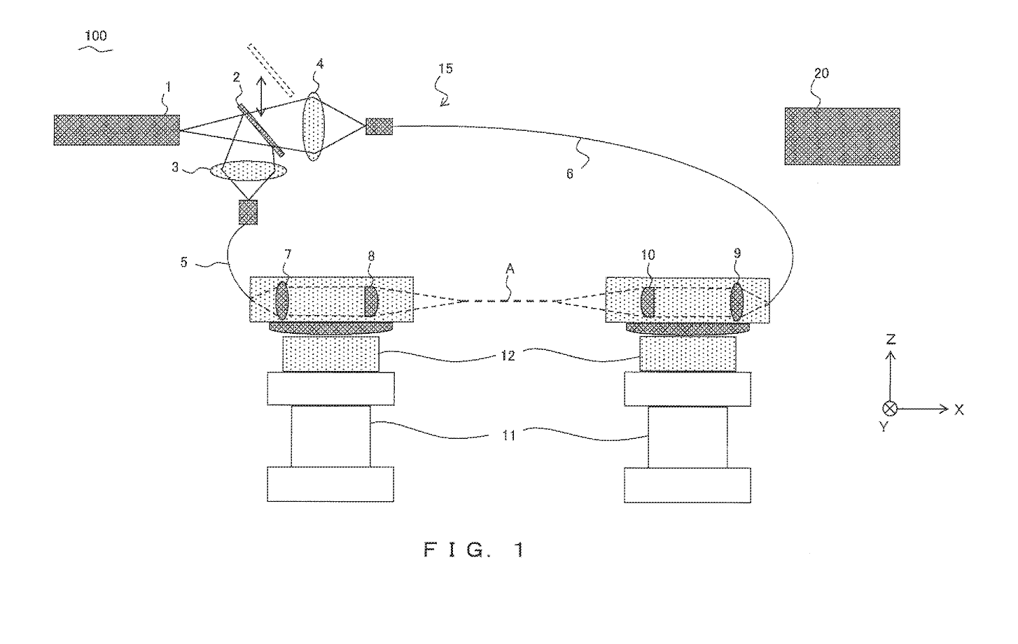

A light sheet illumination microscope 100 according to a first embodiment of the present invention is described below. FIG. 1 illustrates a configuration of the light sheet illumination microscope 100.

The light sheet illumination microscope 100 includes an illumination optical system 15, up-and-down stages 11, tilt stages 12, a stage (not illustrated) that fixes, for example, a sample, a detection optical system (not illustrated) that captures fluorescence from a sample from a Z direction (a height direction) so as to detect fluorescence, and a controller 20.

The illumination optical system 15 includes a light source unit 1, a removable mirror 2, lenses 3 and 4, optical fibers 5 and 6, lenses 7 and 9, and cylindrical lenses 8 and 10.

The light source unit 1 outputs excitation light that is irradiated onto a sample. Further, the light source unit 1 can perform switching between a plurality of wavelengths of the excitation light, in order to observe fluorescence at different wavelengths.

The excitation light from the light source unit 1 is guided in two different directions by inserting and removing the mirror 2, one of two pieces of guided excitation light is irradiated onto a sample through the lens 3, the optical fiber 5, the lens 7, and the cylindrical lens 8; and the other of two pieces of guided excitation light is irradiated onto the sample through the lens 4, the optical fiber 6, the lens 9, and the cylindrical lens 10. In other words, the illumination optical system 15 irradiates a sample with excitation light from a plurality of directions (two directions). The mirror 2 is, for example, a flip mirror, it may be a half mirror. In the case where the mirror 2 is a half mirror, the excitation light is split in the two directions and irradiated onto the specimen simultaneously from the two directions.

The cylindrical lens 8,10 has a power only in the Z direction, and irradiates a sample with excitation light (sheet light) having an expansion in a plane. When a direction of an illumination optical axis is an X direction, a Y direction that is a direction in which the sheet light has an expansion is also referred to as a direction of the width of the sheet light.

The up-and-down stages 11 are provided under a portion of the configuration of the illumination optical system 15 (the lens 7,9 and the cylindrical lens 8,10), and are driven in the Z direction so as to move up and down together with the portion of the configuration of the illumination optical system 15 (the lens 7,9 and the cylindrical lens 8,10). In other words, each of the up-and-down stages 11 is a drive stage that changes, in the Z direction that is the height direction, the emission position of excitation light emitted by the illumination optical system 15.

As in the case of the up-and-down stages 11, the tilt stages 12 are provided under the portion of the configuration of the illumination optical system 15 (the lens 7,9 and the cylindrical lens 8,10), and are driven so as to be tilted together with the portion of the configuration of the illumination optical system 15 (the lens 7, 9 and the cylindrical lens 8,10). In other words, each of the tilt stages 12 is a drive stage that changes the emission direction of the excitation light so as to tilt a plane irradiated with sheet light emitted by the illumination optical system 15.

A component, such as the up-and-down stages 11 and the tilt stages 12, that is configured to change the emission position and direction of excitation light emitted by the illumination optical system is also referred to as a light adjustment mechanism.

Further, in the present embodiment, one up-and-down stage 11 and one tilt stage 12 are provided for each of the two illumination directions of the illumination optical system 15, and they are driven independently of one another. Further, the up-and-down stage 11 and the tilt stage 12 are driven so as to move a portion of the illumination optical system 15, but they may move the entire illumination optical system 15.

In general, there occurs a problem in which, when the wavelength of excitation light output by the light source unit 1 is switched in the above-described configuration in which excitation light is emitted from two directions, an illumination optical path for the two directions is shifted due to the polishing precision of the optical fibers 5 and 6 or and an aberration of each lens, occurring a deviation between two light paths, and this results in irradiating different planes on a sample with two pieces of sheet light.

The configuration according to the embodiments of the present invention that provides a light adjustment mechanism (the up-and-down stage 11 and the tilt stage 12) makes it possible to change the emission position of excitation light when the plane irradiated with sheet light is shifted as described above, which results in being able to prevent such a shift from occurring.

As an exemplary method, the right-and-left light adjustment mechanisms (the up-and-down stages 11 and the tilt stages 12) are moved so as to correct the shift of an irradiated plane with respect to a specified plane for each wavelength, the specified plane being a plane to be irradiated by the illumination optical system 15. Here, correction is performed such that each plane irradiated with excitation light emitted by the illumination optical system 15 matches the specified plane, so the deviation between two irradiated planes formed by two pieces of excitation light from two directions is also corrected. It is assumed that the specified plane is a focal plane A of the detection optical system.

For example, the amount of a shift of an irradiated plane with respect to the specified plane is measured as below.

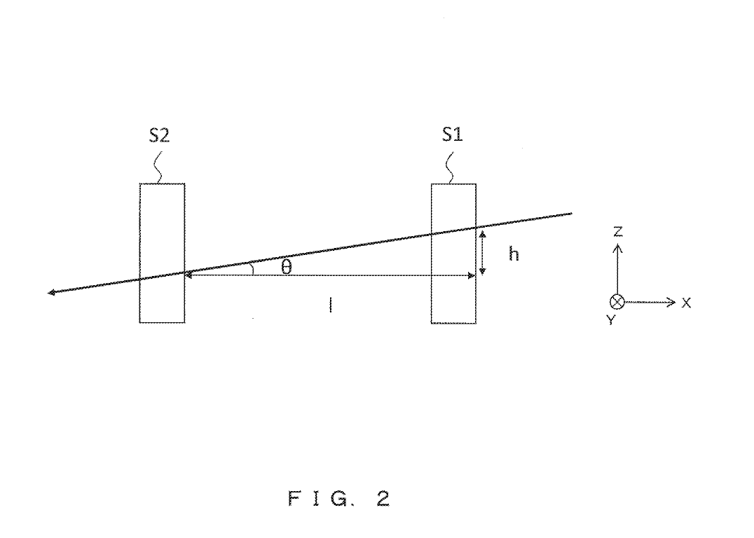

First, the up-and-down stage 11 and the tilt stage 12 in each illumination direction are moved independently of each other such that the up-and-down stage 11 has the same height as the height of the specified plane and the tilt stage 12 is tilted at an angle of zero degrees with respect to the specified plane. In a state in which a wavelength to be used has been selected, optical detectors S1 and S2 are placed at two different points in the X direction in an irradiated plane, as illustrated in FIG. 2, and an angle θ of excitation light with respect to the specified plane is measured using a difference in a height h at which excitation light enters each of the optical detectors and a length 1 between the optical detectors. The amount of a movement to be performed by the tilt stage 12 is a pivoting amount that compensates for the angle θ with respect to the specified plane. The measurement of an angle is performed for each of the two directions.

Next, a coordinate of the up-and-down stage 11 is recorded, the state is changed to an in-focus state by an observer driving the up-and-down stage 11 while reviewing an image, and a coordinate of the up-and-down stage 11 is recorded in the in-focus state. The difference between the coordinate before the up-and-down stage 11 is driven and the coordinate in the in-focus state is the amount of a movement to be performed by the up-and-down stage 11 at a current wavelength. The coordinate is measured in each of the two directions.

The method described above makes it possible to measure an amount of a shift of an irradiated plane with respect to a specified plane in advance for each wavelength of excitation light. Then, when a shift amount at the time of switching the wavelength of excitation light (that is, amounts of movements of the up-and-down stage 11 and the tilt stage 12) is stored in the controller 20, this makes it possible to automatically correct the shift of an irradiated plane with respect to the specified plane according to the correspondence relationship when the wavelength of excitation light output upon performing observation is specified (that is, to correct the deviation between an irradiated plane formed by excitation light from the right side and an irradiated plane formed by excitation light from the left side). The control of the up-and-down stage 11 and the tilt stage 12 will be described later when the functional configuration of the controller 20 is described.

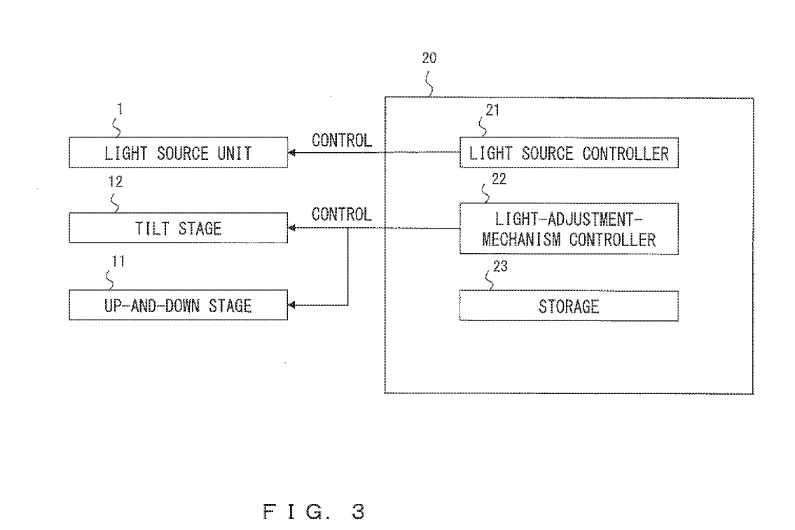

The controller 20 is a computer that controls each component of the light sheet illumination microscope 100. FIG. 3 illustrates a function of the controller 20.

The controller 20 includes a light source controller 21, a light-adjustment-mechanism controller 22, and a storage 23.

The light source controller 21 performs a control to switch the wavelength of excitation light emitted from the light source unit 1 and an on/off control of the light source unit 1.

Using, for example, the method described above, an amount of a shift of an irradiated plane with respect to a specified plane when the wavelength is switched between different wavelengths of excitation light is stored in the storage 23 in advance.

The light-adjustment-mechanism controller 22 performs a control to drive a light adjustment mechanism (the up-and-down stage 11 and the tilt stage 12). The light-adjustment-mechanism controller 22 controls the light adjustment mechanism according to a wavelength of excitation light to be used and according to a relationship between a wavelength of excitation light and a shift amount (a correction amount) that are stored in the storage 23, and changes the emission position of excitation light emitted by the illumination optical system 15. In other words, according to the switching of a wavelength of excitation light emitted by the illumination optical system 15, the light-adjustment-mechanism controller 22 controls a change in emission position performed by a light adjustment mechanism, so as to correct the deviation between irradiated planes formed by pieces of excitation light emitted from a plurality of directions (the position deviation in a height direction and the angle deviation). The light-adjustment-mechanism controller 22 performs a control, for example, when the wavelength of the excitation light is switched by the light source controller 21.

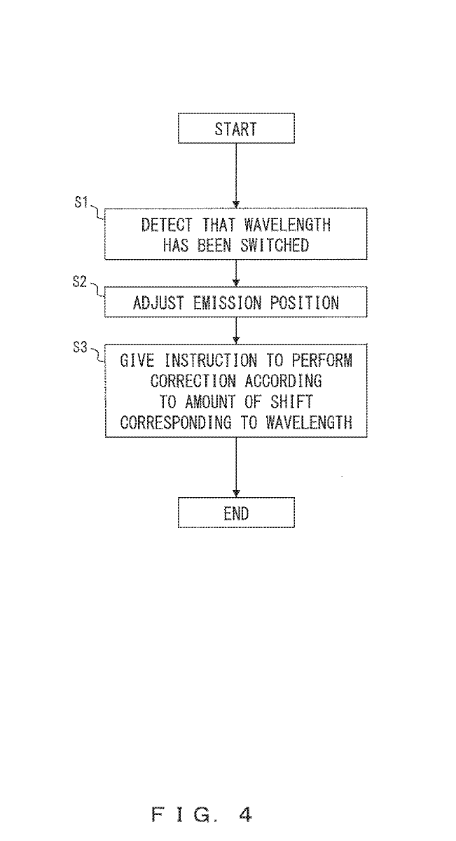

FIG. 4 is a flowchart that illustrates an example of processing performed by the controller 20 when the wavelength of excitation light is switched during observation.

In Step S1, it is detected that the wavelength of excitation light output by the light source unit 1 has been switched.

In Step S2, the movements of the up-and-down stage 11 and the tilt stage 12 in each illumination direction are controlled so as to adjust an emission position, that is, so that the heights of the up-and-down stages 11 in both of the illumination directions are equal to each other and the tilt stages 12 in both of the illumination directions are tilted at an angle of zero degrees with respect to a specified plane.

In Step S3, a shift amount that corresponds to a currently used wavelength of excitation light is read from the storage 23, and a control of the movements of the up-and-down stages 11 and the tilt stages 12 are performed according the shift amount.

The light sheet illumination microscope 100 described above makes it possible to adjust an emission position and an emission direction even when a sample is illuminated from different directions, because the light sheet illumination microscope 100 has the up-and-down stages 11 and the tilt stages 12. Further, the deviation between irradiated planes formed by pieces of excitation light from different illumination directions is automatically corrected by the controller 20 when the wavelength is switched, because a correction amount (amounts of movements of the up-and-down stage 11 and the tilt stage 12) according to excitation light to be emitted is measured and stored in advance.

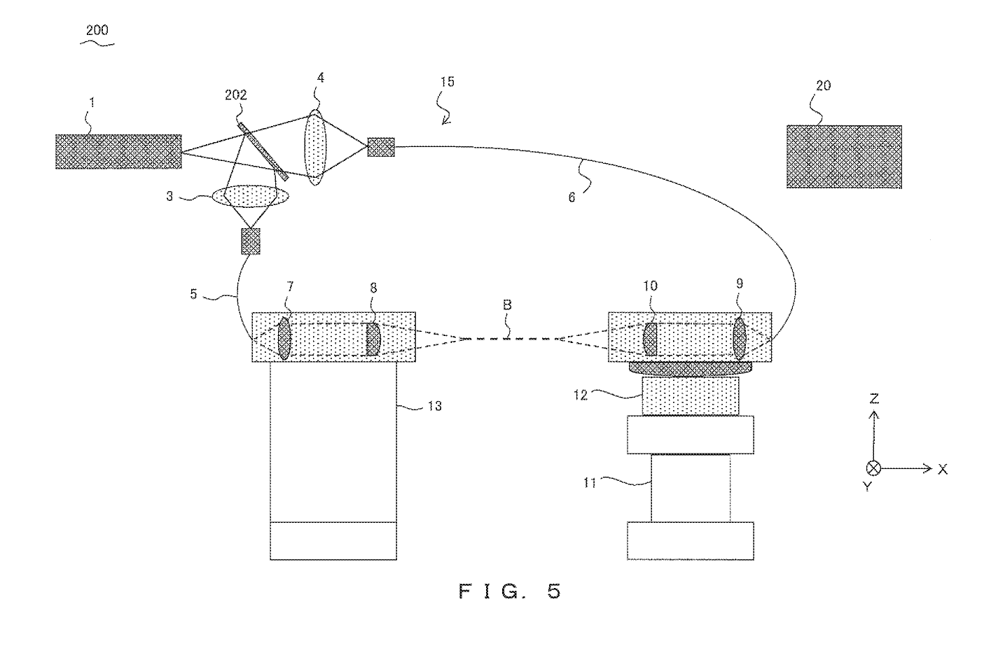

A light sheet illumination microscope 200 according to a second embodiment of the present invention is described below. FIG. 5 illustrates a configuration of the light sheet illumination microscope 200.

The light sheet illumination microscope 200 is different from the light sheet illumination microscope 100 in that the light sheet illumination microscope 200 does not include a light adjustment mechanism (the up-and-down stage 11 and the tilt stage 12) that changes the emission position and the emission direction of excitation light for an illumination optical path in one of the two different illumination directions, but it is similar to the light sheet illumination microscope 100 in regard to the other points. In the light sheet illumination microscope 200, a base 13 used to fix an optical system is provided in the position in which the light adjustment mechanism is provided under the lens 7 and the cylindrical lens 8 in the light sheet illumination microscope 100. The light sheet illumination microscope 200 includes a beam splitter 202 instead of the removable mirror 2. The beam splitter 202 is, for example, a half mirror.

In this configuration, in order to prevent the deviation between irradiated planes formed by pieces of excitation light from two illumination directions from occurring, the position to be irradiated is changed using the up-and-down stage 11 and the tilt stage 12 such that the irradiated plane is a plane B irradiated with sheet light from the optical system (including the cylindrical lens 8) on which an adjustment using a light adjustment mechanism is not performed. Also in this case, the deviation between irradiated planes formed by pieces of light from two different directions (the shift with respect to the irradiated plane B) is constant for each wavelength, and it is possible to automatically perform a correction upon observing a sample by performing the deviation measurement in advance, as in the case of the light sheet illumination microscope 100.

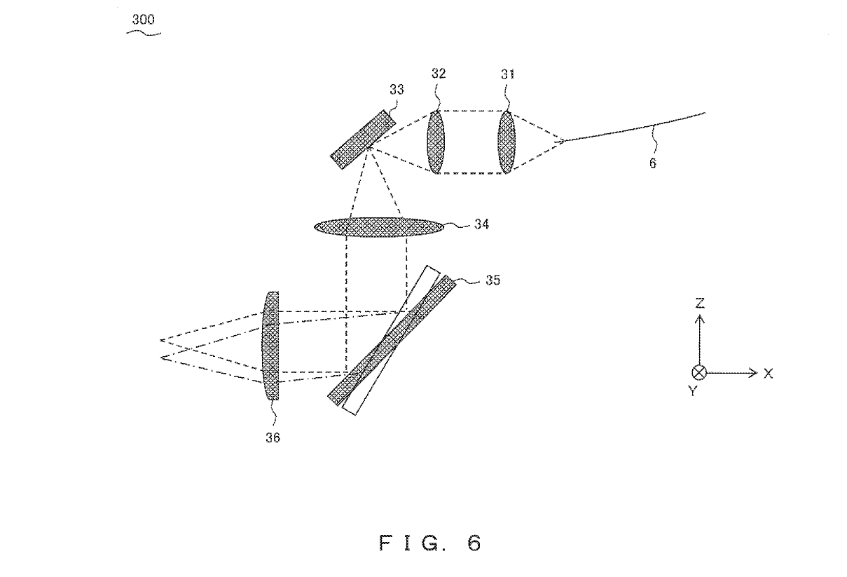

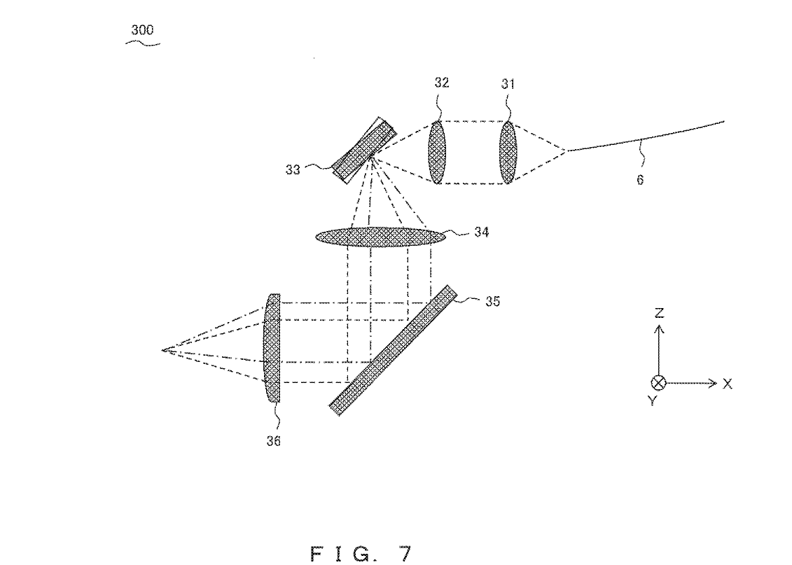

A light sheet illumination microscope 300 according to a third embodiment of the present invention is described below. FIGS. 6 and 7 illustrate a portion of a configuration of the light sheet illumination microscope 300.

The light sheet illumination microscope 300 has a configuration similar to the configuration of the light sheet illumination microscope 100 except that the light sheet illumination microscope 300 includes a light adjustment mechanism having a different configuration from that included the light sheet illumination microscope 100. The light sheet illumination microscope 300 includes lenses 31 and 32, a galvanometer mirror 33, a lens 34, a galvanometer mirror 35, and a cylindrical lens 36 on the output side of the optical fiber 6 (5) when the side close to the light source unit 1 is considered to be the input side of the optical fiber 6 (5).

As illustrated in FIG. 6, when the galvanometer mirror 35 is driven, excitation light is deflected in the illumination optical system 15 and the emission position of the excitation light is changed, so as to move a plane irradiated with sheet light in the Z direction. In other words, the galvanometer mirror 35 plays a role similar to that of the up-and-down stage 11.

As illustrated in FIG. 7, when the galvanometer mirror 33 is driven, excitation light is deflected in the illumination optical system 15 and the emission position of the excitation light is changed, so as to tilt a plane irradiated with sheet light. In other words, the galvanometer mirror 33 plays a role similar to that of the tilt stage 12.

As described above, it is also possible to use, as a light adjustment mechanism, the galvanometer mirror 33 and the galvanometer mirror 35 that are drive mirrors. The configuration according to the present embodiment that uses galvanometer mirrors makes it possible to adjust the emission position and the emission direction of excitation light more rapidly, and to reduce, for example, the impact that a vibration caused upon driving the galvanometer mirrors has on a device or a sample, compared to the case of the configuration in which stages are driven.

According to the present invention, in a light sheet illumination microscope that illuminates a sample from different directions, it is possible to correct a deviation between irradiated planes formed by pieces of excitation light from different illumination directions, the deviation being due to the shift occurring when the wavelength of excitation light is switched.

The embodiments described above are just examples to facilitate understanding of the present invention, and the embodiment of the present invention is not limited to these examples. Various modifications and alterations may be made to the light sheet illumination microscope described above without departing from the scope of the invention specified in the claims.

What is claimed is:

1. A light sheet illumination microscope comprising:
an illumination optical system that emits excitation light to a sample from a plurality of directions;
a light adjustment mechanism that changes an emission position and an emission direction of the excitation light emitted by the illumination optical system; and
a controller that controls the light adjustment mechanism according to a switching of a wavelength of the excitation light emitted by the illumination optical system, so as to correct a deviation between irradiated planes formed by pieces of excitation light emitted from the plurality of directions.

2. The light sheet illumination microscope according to claim 1, wherein
the light adjustment mechanism changes the emission positon in a height direction, and
the controller performs a control of a change in the emission position that is performed by the light adjustment mechanism, so as to correct a position deviation in a height direction between irradiated planes formed by pieces of excitation light emitted from the plurality of directions.

3. The light sheet illumination microscope according to claim 1, wherein
the light adjustment mechanism changes the emission direction so as to tilt the emission direction of the excitation light emitted by the illumination optical system, and
the controller performs a control of a change in the emission direction that is performed by the light adjustment mechanism, so as to correct an angle deviation between irradiated planes formed by pieces of excitation light emitted from the plurality of directions.

4. The light sheet illumination microscope according to claim 2, wherein
the light adjustment mechanism is a drive stage that moves at least a portion of the illumination optical system.

5. The light sheet illumination microscope according to claim 2, wherein
the light adjustment mechanism is a drive mirror that deflects excitation light in the illumination optical system.

6. The light sheet illumination microscope according to claim 1, wherein
the controller controls the light adjustment mechanism according to a shift of an irradiated plane with respect to a specified plane, so as to correct the shift, the shift depending on the wavelength of the excitation light emitted by the illumination optical system.

7. The light sheet illumination microscope according to claim 1, wherein
the controller controls the light adjustment mechanism according to a deviation between irradiated planes, so as to correct the deviation, the deviation between the irradiated planes being a deviation of one irradiated plane formed by excitation light from one direction with respect to another irradiated plane formed by the excitation light from another direction, the excitation light being light emitted to the sample by the illumination optical system, the deviation depending on a wavelength of the excitation light.
